(19) United States
(12) Patent Application Publication
(10) Pub. No.: US 2025/0080372 A1
(43) Pub. Date: Mar. 6, 2025

(54) AUTOMATIC SUGGESTION AND GENERATION OF MEETING SCHEDULES

(71) Applicant: Zoom Video Communications, Inc., San Jose, CA (US)

(72) Inventors: Qiumin Dong, Suzhou (CN); Helgi Hilmarsson, San Francisco, CA (US); Wei Ji, San Jose, CA (US); Bilung Lee, Irvine, CA (US); Vijay Venkataswamy Parthasarathy, San Jose, CA (US); Sasank Vemuri, Austin, TX (US)

(73) Assignee: Zoom Video Communications, Inc., San Jose, CA (US)

(21) Appl. No.: 18/794,530

(22) Filed: Aug. 5, 2024

Related U.S. Application Data
(63) Continuation of application No. PCT/CN2023/116813, filed on Sep. 4, 2023.

(51) Int. Cl. H04L 12/18; G06F 40/35; H04L 51/046; H04L 51/216

(52) U.S. Cl. CPC H04L 12/1818; G06F 40/35; H04L 12/1831; H04L 51/046; H04L 51/216

(57) ABSTRACT

Example methods and systems for automatic suggestion and generation of meeting schedules are provided. A communication platform accesses virtual interaction data associated with a virtual interaction. The communication platform detects a meeting intent based on the virtual interaction data. The communication platform also predicts multiple meeting attendees, determines one or more meeting times, and generates a meeting title based on the virtual interaction data and other related data. The communication platform provides a meeting schedule suggestion to a participant in the virtual interaction. The meeting schedule suggestion includes the meeting title, identifications of the multiple attendees, and the one or more meeting times.

### CROSS-REFERENCE TO RELATED APPLICATIONS

This application is a continuation application of PCT Patent Application No. PCT/CN2023/116813, filed Sep. 4, 2023, titled “AUTOMATIC SUGGESTION AND GENERATION OF MEETING SCHEDULES,” the entirety of which is hereby incorporated by reference.

### FIELD

The present application generally relates to virtual conferencing and more specifically relates to automatic suggestion and generation of meeting schedules.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing and chat functionality to various client devices;

FIG. 2 shows an example system in which a chat and video conference provider provides videoconferencing and chat functionality to various client device;

FIG. 3 shows an example system that automatically suggests and

generates a meeting schedule;

FIG. 4 shows an example system that is configured to configured to automatically suggest and generate a meeting schedule during a virtual interaction;

FIG. 5A shows an example chat panel.

FIG. 5B shows a consent authorization request for automatically accessing interaction data;

FIG. 5C shows a meeting schedule suggestion in a GUI element;

FIG. 6 shows an example method for automatically suggesting and generating a meeting schedule during a virtual interaction;

FIG. 7 shows an example computing device suitable for use in example systems or methods for facilitating user actions for virtual interactions, according to certain examples.

### DETAILED DESCRIPTION

Examples are described herein in the context of automatic suggestion and generation of meeting schedules. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Virtual interactions, such as online chats, video conferences, or any other online interactions, involve a conversation between different users. Users in a virtual conversation may discuss certain future actions, such as a follow up meeting with some users. For example, users in an online chat session are discussing the next step about a project, which involves a meeting with different parties. It may take a long time for the users to determine who should attend the next meeting and what is the best time for possible attendees during the chat session. Still, the users may not identify all the possible attendees or the best time for the next meeting during the chat session or after the chat session.

To facilitate users to schedule a future meeting, it is desirable for a communication platform to automatically suggest and generate a future meeting schedule during a virtual conversation. The communication platform or the client application provided by the communication platform can generate a meeting schedule suggestion during a chat session, a virtual conference, a sequence of email communication, or any other virtual interactions that involve a virtual conversation between two or more users.

In an example, a communication platform establishes an online chat session between two or more users. The two or more users interact with each other via client devices installed with a client application provided by the communication platform. The communication platform includes an intent detection engine and a meeting schedule generator. The intent detection engine can implement a natural language processing (NLP) model to recognize or detect a meeting intent based on the chat messages and associated user identifications (IDs) in the online chat session. If the intent detection engine on the communication platform detects a meeting intent, it can generate a meeting intent message to the meeting schedule generator.

The meeting schedule generator can include a meeting attendee prediction module, a meeting time suggestion module, and a meeting title generation module. The meeting attendee prediction module is configured to predict meeting attendees for the meeting. The meeting attendee prediction module can extract user IDs that are mentioned in the chat messages and user IDs that participate in the chat session. The meeting attendee prediction module can also determine a social graph based on historical chat data, other historical interaction data, and profile data associated with the users ID mentioned or participating in the chat session. The social graph represents relationships between different user IDs. The meeting attendee prediction module can predict meeting attendees based on the social graph.

The meeting time suggestion module is configured to generate one or more meeting time suggestions. The meeting time suggestion module can extract meeting time data from the chat messages. The meeting time suggestion module can also access calendar data associated with the predicted meeting attendees to determine availabilities of the predicted meeting attendees. One or more meeting time suggestions can be generated based on the extracted meeting time data and the calendar data associated with the predicted meeting attendees.

The meeting title generation module is configured to generate a meeting title. In some examples, the meeting title generation module implements a generative AI model to generate a meeting title based on chat messages in the chat session.

The meeting schedule generator can generate a meeting schedule suggestion including the predicted meeting attendees, the one or more meeting time suggestions, and the generated meeting title. The meeting scheduling suggestion can also include a meeting location. If it is an in-person meeting, the location can be extracted from the chat messages. If it is a virtual meeting, the location can be a meeting link provided by the communication platform.

The meeting schedule generator can provide the meeting scheduling suggestion in a pop-up window to a user in the chat session, where the meeting attendee data, meeting time data, meeting title, meeting location data, and other suitable information is automatically filled. The user can edit the information in the popup window and send out the meeting schedule as a calendar invite or in any other suitable means. In some examples, the meeting scheduling suggestion is displayed as a GUI element in the GUI of the chat session on a client device associated with a user. The GUI element is linked to a meeting application. If a user presses or clicks the GUI element, it triggers a scheduling window provided by the meeting application to be displayed, with the meeting attendee data, meeting time data, meeting title data, meeting location data, and other suitable information is automatically filled. The user can edit the information and send the meeting schedule as a calendar invite or in any other suitable means.

Thus, this example provides a meeting schedule suggestion during a virtual conversation. The meeting schedule suggestion includes predicted meeting attendee information, suggested meeting times when the meeting attendees are available, a generated meeting title, or any other suitable information in a meeting schedule. Users in the virtual conversation do not need to find out the attendees and time manually. The users can edit the information in the meeting schedule suggestion based on user preferences. The automatically generated meeting schedule suggestion saves user time and provide more accurate information to the users for meeting scheduling.

Applicant's goal is to invest in AI-driven innovation that enhances user experience and productivity while prioritizing trust, safety, and privacy. Applicant does not use any customer audio, video, chat, screen-sharing, attachments, or other communications-like customer content (such as poll results, whiteboards, or reactions) to train Applicant's or third-party artificial intelligence models. Additionally, AI Companion is turned off by default-account owners and administrators control whether to enable these AI features for their accounts. Applicant provides admins and users control and visibility when AI features are being used or activated. By putting its customers' privacy needs first, Applicant is taking a leadership position, enabling its customers to use AI Companion and its capabilities with confidence.

This illustrative example is given to introduce the reader to the general subject matter discussed herein and the disclosure is not limited to this example. The following sections describe various additional non-limiting examples and examples of automatic suggestion and generation of meeting schedules.

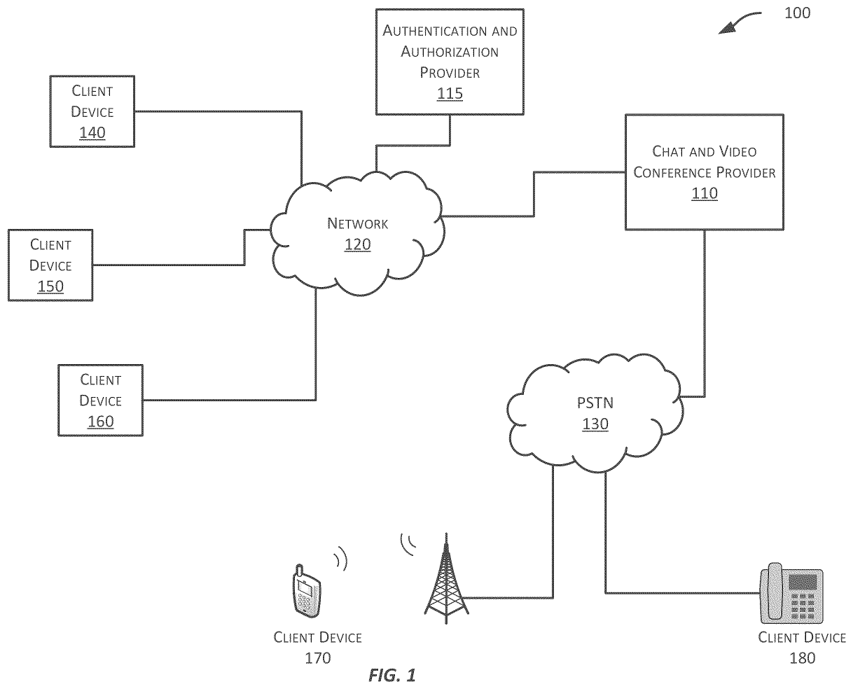

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

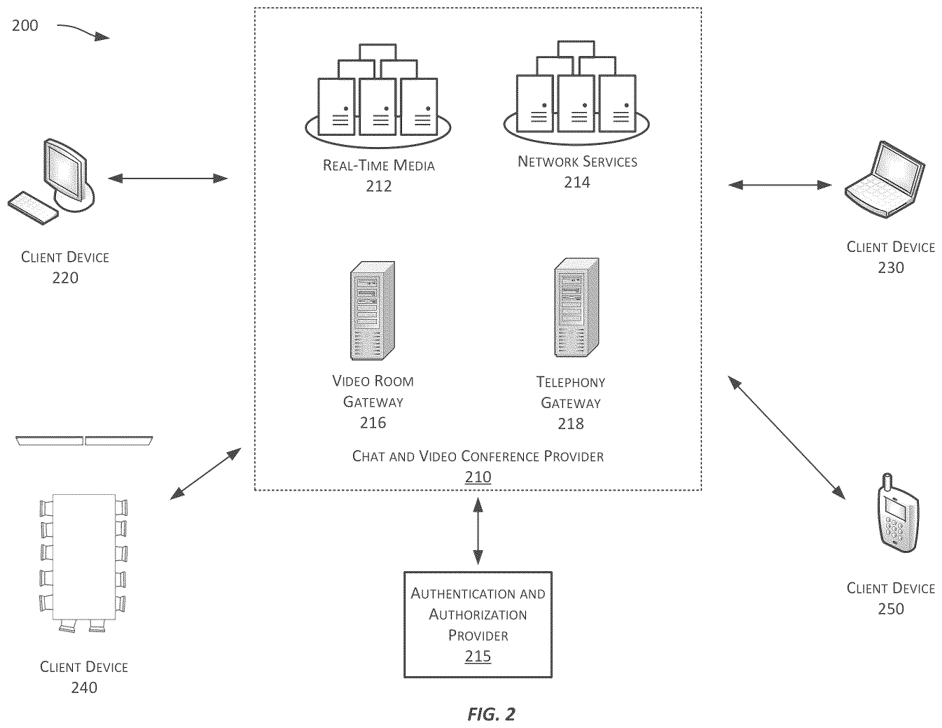

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

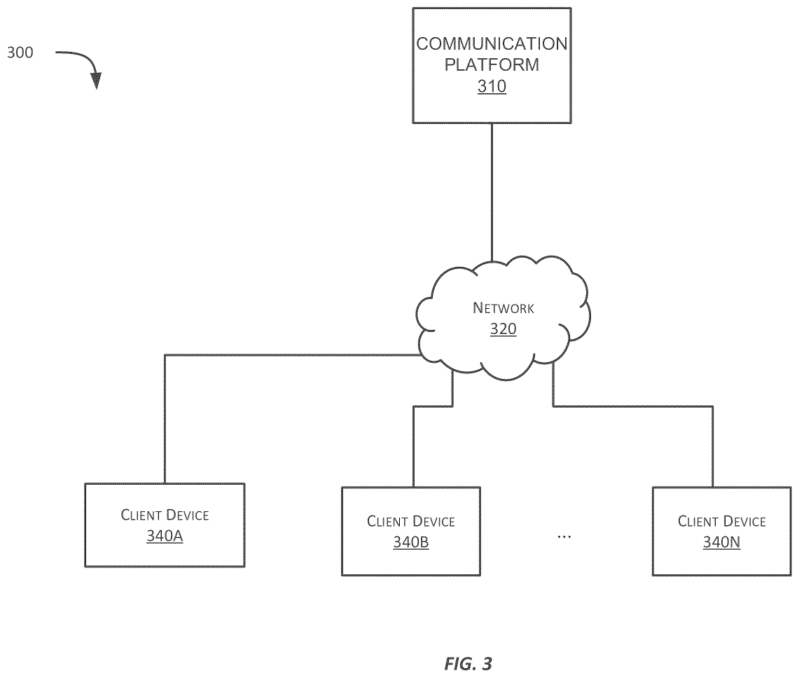

Referring now to FIG. 3, FIG. 3 shows an example system 300 that automatically suggests and generates a meeting schedule. In this example system 300, a communication platform 310 and a number of client device 340A-340N (which may be referred to herein individually as a client device 340 or collectively as the client devices 340) are connected via a network 320. The communication platform 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a chat session, a user associated a client device (e.g., client device 340A) can interact with other users associated with other client devices (e.g., client device 340B-340N) via the communication platform 310 by sending and receiving chat messages, and reacting to received chat messages.

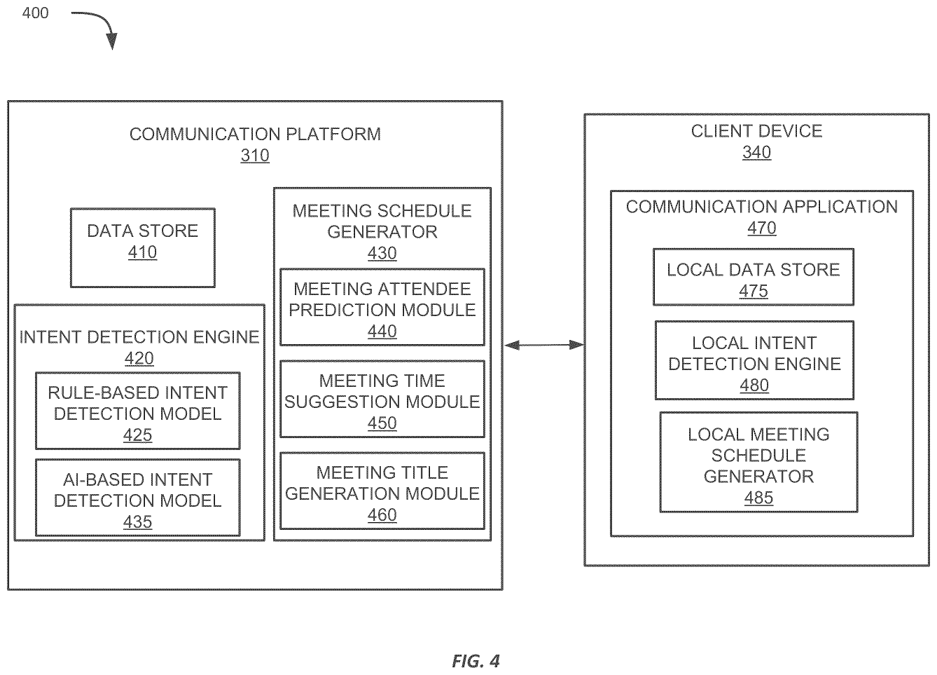

Now referring to FIG. 4, FIG. 4 shows an example system 400 that is configured to automatically suggest and generate a meeting schedule during a virtual interaction. The communication platform 310 is in network communication with a client device 340. The client device 340 is installed with a communication application 470 provided by the communication platform 310.

The communication platform 310 includes a data store 410, an intent detection engine 420, and a meeting schedule generator 430. The data store 410 stores interaction data from different client devices 340. The interaction data can include historical interaction data and live interaction data, such as emails, chat messages, and meeting transcripts. The data store 410 can also include profile data associated with different users on the communication platform 310, including account identifications, names, organizations, job titles, or any suitable data related to a user's profile. In some examples, the data store 410 also includes calendar data associated with different users on the communication platform, including availability at different time slots on different days.

The intent detection engine 420 is configured to detect a meeting intent from the interaction data during a virtual interaction between different users. In some examples, the intent detection engine 420 includes a rule-based intent detection model 425. The rule-based intent detection model 425 implements rules associated with a set of keywords. Some example keywords can include “meeting,” “schedule,” “calendar,” etc. An example rule is if there are two or more keywords mentioned in the interaction data during a two-minute period, the rule-based intent detection model 425 determines that there is a meeting intent. The rule-based intent detection model 425 can search certain keywords in interaction data associated with a virtual interaction to determine if there is a meeting intent by comparing to a keyword-based rule. In some examples, the rule-based intent detection model 425 generates a likelihood score representing the likelihood of an intent to schedule a future meeting based on the search and compare the likelihood score to a threshold score. If the likelihood score is equal to or greater than the threshold score, the rule-based intent detection module determines that there is a meeting intent. If the likelihood score is less than the threshold score, the intent detection module on the client application determines that there is no meeting intent. Alternatively, or additionally, the intent detection engine 420 can implement an AI-based intent detection model 435. For example, the AI-based intent detection model is a sequence model, such as recurrent neural networks (RNNs) and transformers, trained to detect intent from input sequences.

In some examples, both the rule-based (keyword-based) intent detection model 425 and the AI-based intent detection model 435 are implemented. The rule-based intent detection model 425 provides a low latency and high recall output. In other words, the rule-based intent detection model 425 provides fast and relevant results. It can function as a filter for the AI-based intent detection model 435. If the rule-based intent detection model 425 detects a meeting intent from the interaction data, the AI-based intent detection model 435 can further verify the meeting intent. If the rule-based intent detection model 425 does not detect a meeting intent, the AI-based intent detection model 435 may not further verify the meeting intent.

If the intent detection engine 420 determines that there is a meeting intent based on the interaction data, the intent detection engine 420 can send a meeting intent message to the meeting schedule generator 430. The meeting schedule generator 430 is configured to generate a meeting schedule suggestion, including a meeting title, meeting attendees, meeting time, and any other suitable information in a meeting schedule for a future meeting. The meeting schedule generator 430 includes a meeting attendee prediction module 440, a meeting time suggestion module 450, and a meeting title generation module 460.

The meeting attendee prediction module 440 is configured to predict meeting attendees for a future meeting. The meeting attendee prediction module 440 can extract user IDs that are mentioned in the interaction data during the virtual interaction and user IDs that participate in the virtual interaction. The meeting attendee prediction module 440 can also determine a social graph based on historical interaction data and profile data associated with the users ID mentioned or participating in the current virtual interaction. The social graph represents relationships between different user IDs. In some examples, the social graph is predetermined by the communication platform 310 and the meeting schedule generator 430 can access to the predetermined social graph. The meeting attendee prediction module 440 can predict additional meeting attendees based on the social graph.

The meeting time suggestion module 450 is configured to generate one or more meeting time suggestions. The meeting time suggestion module 450 can extract meeting time data from interaction data during the virtual interaction. The meeting time suggestion module 450 can also access calendar data associated with the predicted meeting attendees to determine availabilities of the predicted meeting attendees. One or more meeting times may be suggested based on the extracted meeting time data and the calendar data associated with the predicted meeting attendees.

The meeting title generation module 460 is configured to generate a meeting title. In some examples, the meeting title generation module 460 implements a pre-trained generative AI model or other NLP models to generate a meeting title based on interaction data during the virtual interaction. For example, the meeting title generation module 460 can extract a topic related to a further meeting that participants in a virtual interaction are discussing about. The topic can be used to generate the meeting title.

The meeting schedule generator 430 can also include a meeting location extraction module (not shown). The meeting location extraction module can determine if the future meeting being discussed in the virtual interaction is an in-person meeting. If it is an in-person meeting, location data associated with the future meeting can be extracted from the interaction data. If it is a virtual meeting, the location can be a meeting link provided by the communication platform 310 or a third-party platform. The meeting schedule generator 430 can also include a meeting agenda generation module (not shown). The meeting agenda generation module can implement a pre-trained generative AI model to generate a meeting agenda based on interaction data during the virtual interaction or other related data.

The meeting schedule generator 430 can generate a meeting schedule suggestion including predicted meeting attendee information, one or more suggested meeting times, a meeting title, a meeting location, and any other suitable information in a meeting schedule. In some examples, the meeting schedule generator 430 determines one or more participants in the virtual interaction for receiving the meeting schedule suggestion. The meeting schedule generator 430 can implement an NLP model to determine one or more participants based on the interaction data and corresponding participants.

In some examples, the meeting schedule generator 430 provides the meeting scheduling suggestion in a popup window to a participant in the virtual interaction via a communication application 470 installed on a client device 340 associated with the participant. The meeting attendee data, meeting time data, meeting title, meeting location data, and other suitable information can be automatically filled in the popup window. The user can edit the information in the popup window and send out the meeting schedule as a calendar invite or in any other suitable means. In some examples, the meeting scheduling suggestion is displayed as a GUI element in the GUI of the communication application 470 installed on a client device 340 associated with a participant. The GUI element can be linked to a meeting scheduling application. If a user presses or clicks the GUI element, it triggers a scheduling window provided by the meeting application to be displayed, with the meeting attendee data, meeting time data, meeting title data, meeting location data, and other suitable information is automatically filled. The user can edit the information and send the meeting schedule as a calendar invite or in any other suitable means.

The communication application 470 installed on the client device 340 includes a local data store 475. The local data store 475 can store historical interaction data and live interaction data, profile data, calendar data, or any other suitable data related to a user associated with the client device 340. In some examples, the communication application 470 can also include a local intent detection engine 480 and a local meeting schedule generator 485, similar to the intent detection engine 420 and the meeting schedule generator 430 on the communication platform 310. In some examples, the local intent detection engine 480 implements a keyword-based intent detection module to determine whether there is an intent for a future meeting based on interaction data in an ongoing virtual interaction, similar to the rule-based intent detection model 425 in an intent detection engine 420 on the communication platform 310. If the keyword-based intent detection module determines there is an intent for a future meeting, the local intent detection engine 480 can transmit a meeting intent message to trigger the intent detection engine 420 on the communication platform 310 to verify the meeting intent, which can transmit a verified meeting intent message to the meeting schedule generator 430 for generating a meeting schedule suggestion.

In some examples, the local intent detection engine 480 implements an AI-based intent detection model, similar to the AI-based intent detection model 435 implemented by the intent detection engine 420 on the communication platform, for independently determining a meeting intent or verifying a meeting intent determined by a keyword-based intent detection model. In some examples, the local meeting schedule generator 485 generates a meeting schedule suggestion, similar to the meeting schedule generator 430. The local meeting schedule generator 485 can request access to calendar data, social graph, or other data needed for generating a meeting schedule.

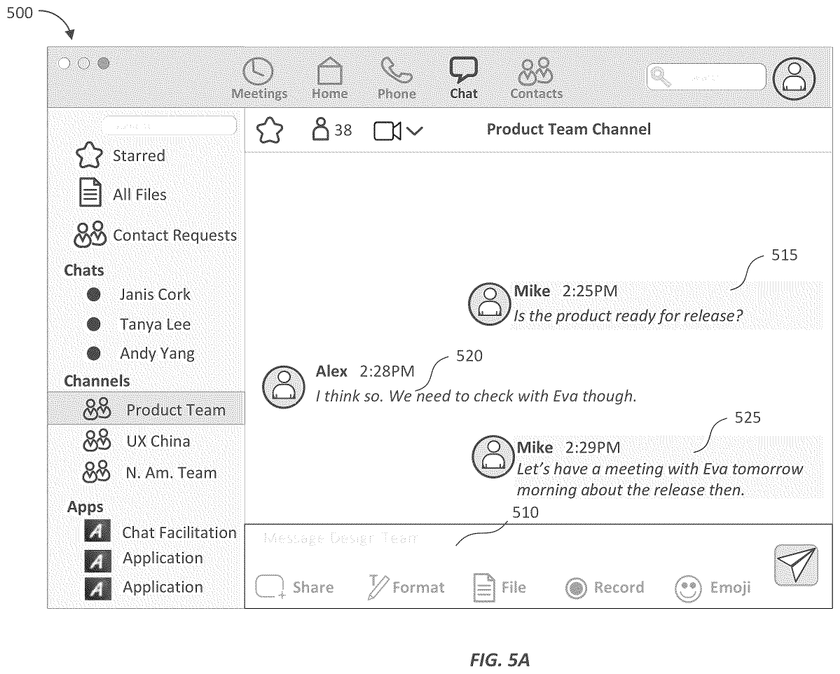

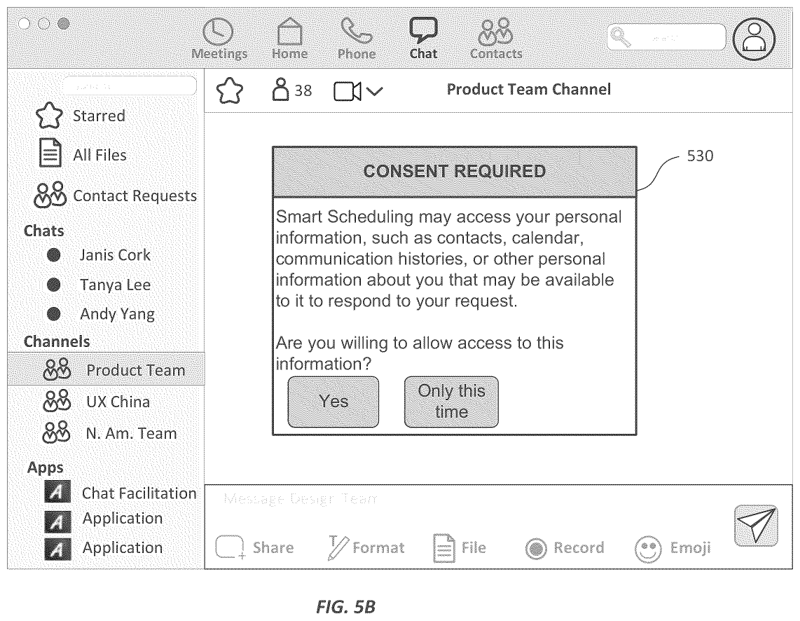

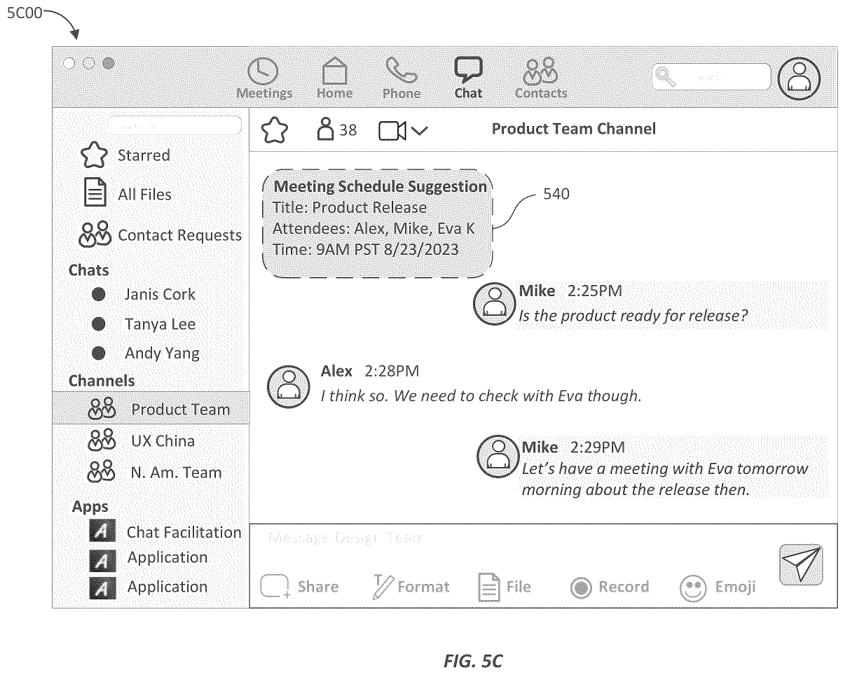

Now referring to FIG. 5, FIG. 5 shows an example chat panel 500 displaying a meeting schedule suggestion in a GUI element 530. The chat panel 500 is a GUI of a communication application 470 provided by the communication platform 310 and installed on a client device 340. The chat panel 500 may include a chat window 505 and a chat message entering panel 510. In this example, the chat window 505 displays three chat messages 515, 520, and 525.

Now referring to FIG. 5B, FIG. 5B shows a consent authorization request for accessing personal data. A user may activate a smart scheduling feature before or during a chat session. If the user elects to activate the smart scheduling feature, a consent authorization is displayed in a GUI element 530 for the user to interact with. The consent authorization informs the user that the smart scheduling feature may involve the intent detection engine 420 and the meeting schedule generator 430 accessing multiple different types of information, which may be personal to the user. the user can then decide whether to grant permission to the smart scheduling feature generally or only for this request. Alternatively, the user can decline to provide permission, which may prevent the intent detection engine 420 and the meeting schedule generator 430 and other components related to smart scheduling from accessing the user's personal information.

Now referring to FIG. 5C, FIG. 5C shows an interactive GUI element 540 presenting a meeting schedule suggestion. The meeting schedule suggestion includes a meeting title, a list of attendees, and a meeting time. The meeting schedule suggestion can be generated by a meeting schedule generator 330 based on the chat messages (e.g., 515, 520, 525) in the chat session, calendar data, and other related data. The GUI element 540 presenting the meeting schedule suggestion can be generated by the communication application 470. The GUI element 540 can be interactive. A user can click or press the GUI element 540, which triggers a scheduling window to be displayed (not shown in FIG. 5). The user can edit the title, attendee information, the meeting time, or any other information in the scheduling window and send the schedule to the attendees.

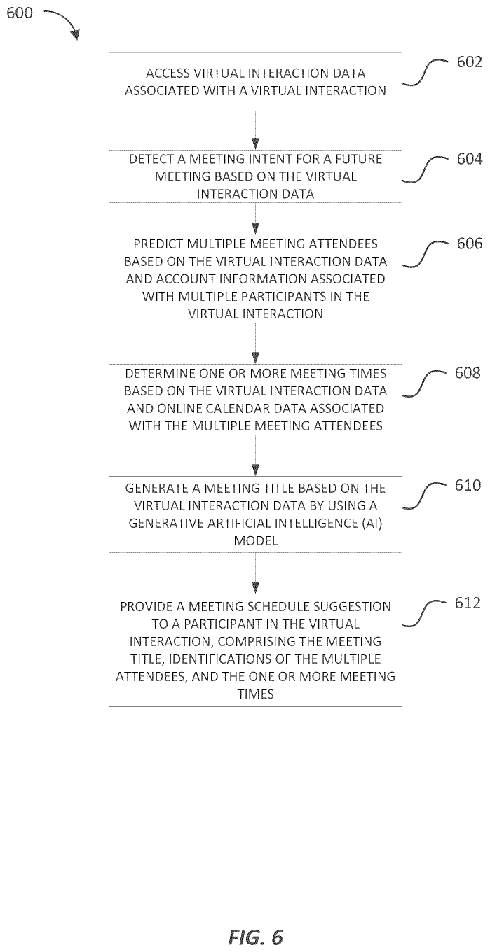

Now referring to FIG. 6, FIG. 6 shows an example method 600 for automatically suggesting and generating a meeting schedule during a virtual interaction. The example method 600 will be discussed with respect to the system 400 shown in FIG. 4; however, any suitable system for facilitating user actions may be used.

At block 602, a communication platform 310 accesses virtual interaction data associated with a virtual interaction. The communication platform 310 can establish the virtual interaction between multiple participants. The virtual interaction can be an online chat session, and the virtual interaction data can include real-time chat messages in the online chat session. The virtual interaction can be a virtual conference, and the virtual interaction data can include a live transcript for the virtual conference. The virtual interaction can be an active email thread, and the virtual interaction data can include a sequence of emails.

At block 604, the communication platform 310 detects a meeting intent for a future meeting based on the virtual interaction data. The intent detection engine 420 on the communication platform 310 can detect a meeting intent for a future meeting based on the virtual interaction data, using a rule-based intent detection model 425 or an AI-based intent detection model 435 or both, generally as described in FIG. 4. In some examples, a communication application 470 can detect a meeting intent based on meeting related keywords, and triggers the intent detection engine 420 to further verify the meeting intent using the AI-based intent detection model 435.

At block 606, the communication platform 310 predicts multiple meeting attendees based on the virtual interaction data and account information associated with multiple participants in the virtual interaction. If a meeting intent is detected, the intent detection engine 420 transmits a meeting intent message to the meeting schedule generator 430 on the communication platform. The meeting attendee prediction module 440 in the meeting schedule generator 430 can predict multiple attendees based on the virtual interaction data and account information associated with the multiple participants in the virtual interaction, generally as described in FIG. 4. For example, the meeting attendee prediction module 440 can extract users mentioned in the virtual interaction data and generates a social graph representing relationships between the multiple participants in the virtual interaction, users mentioned in the virtual interaction, and other users, based on historical interaction data and profile data.

At block 608, the communication platform 310 determines one or more meeting times based on the virtual interaction data and online calendar data associated with the multiple meeting attendees. The meeting time suggestion module 450 in the meeting schedule generator 430 on the communication platform 310 can determine one or more meeting times, generally as described in FIG. 4. For example, the meeting time suggestion module 450 can extract meeting time data from the virtual interaction data and access calendar data related to the multiple attendees predicted at block 606. The meeting time suggestion module 450 can determine the one or more meeting times based on the availability of the multiple attendees.

At block 610, the communication platform 310 generates a meeting title based on the virtual interaction data by using a generative artificial intelligence (AI) model. The meeting title generation module 460 in the meeting schedule generator 430 on the communication platform 310 can generate a meeting title, generally as described in FIG. 4. For example, the meeting title generation module 460 can extract a topic related to a future meeting being discussed during the virtual interaction, based on the virtual interaction data by using a generative AI model. For example, the topic for a future meeting is about a product release. The title of the future meeting can be generated as “product release.”

At block 612, the communication platform 310 provides a meeting schedule suggestion to a participant in the virtual interaction, the meeting schedule suggestion comprising the meeting title, identifications of the multiple attendees, and the one or more meeting times. The meeting schedule generator 430 can generate a meeting schedule suggestion including identifications of the multiple attendees predicted at block 606, and one or more meeting times suggested at block 608, and the meeting title generated at block 610. The meeting schedule suggestion can also include other suitable information, such as location, either virtual or physical. The meeting schedule suggestion can be presented in a GUI element on the communication application 470 installed on a client device 340, which can trigger a scheduling window with relevant information automatically filled. Alternatively, a scheduling window can be automatically displayed as a popup window on the client device 340, with the relevant information automatically filled and the participant associated with the client device 340 can edit the meeting schedule.

The example process 600 illustrates a method for automatically suggesting and generating a meeting schedule. However, not every step in the example process 600 may be needed, or some steps may be in a different order. For example, operations in blocks 606, 608, and 610 can be performed in different orders. Also for example, additional information may be determined for a meeting schedule, such as a location, and other related information about the meeting (e.g., dress code, food, beverage, etc.). The example process 600 is performed by a communication platform 310. Alternatively, the example process 600 can be performed by a communication application 470 installed on a client device 340.

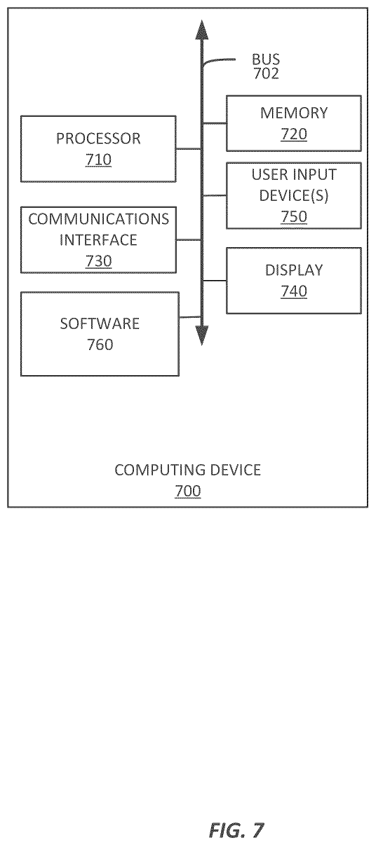

Now referring to FIG. 7, FIG. 7 shows an example computing device 700 suitable for use in example systems or methods for automatic suggestion and generation of meeting schedules. The example computing device 700 includes a processor 710 which is in communication with the memory 720 and other components of the computing device 700 using one or more communications buses 702. The processor 710 is configured to execute processor-executable instructions stored in the memory 720 to perform one or more methods for facilitating user actions for virtual interactions, such as part or all of the example method 600, described above with respect to FIG. 6. The computing device, in this example, also includes one or more user input devices 750, such as a keyboard, mouse, touchscreen, video input device (e.g., one or more cameras), microphone, etc., to accept user input. The computing device 700 also includes a display 740 to provide visual output to a user. The computing device 700 may also include a software 760. The software 760 may include a client application, a communication platform, and any other software to enable communication from a first user to a second user.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing virtual interaction data associated with a virtual interaction;
detecting a meeting intent for a future meeting based on the virtual interaction data;
predicting multiple meeting attendees based on the virtual interaction data and account information associated with multiple participants in the virtual interaction;
determining one or more meeting times based on the virtual interaction data and online calendar data associated with the multiple meeting attendees;
generating a meeting title based on the virtual interaction data by using a generative artificial intelligence (AI) model; and
providing a meeting schedule suggestion to a participant in the virtual interaction, the meeting schedule suggestion comprising the meeting title, identifications of the multiple attendees, and the one or more meeting times.

2. The method of claim 1, wherein the virtual interaction is an online chat session, and wherein the virtual interaction data comprises real-time chat messages in the online chat session.

3. The method of claim 1, wherein the virtual interaction is a virtual conference, and wherein the virtual interaction data comprises a live transcript for the virtual conference.

4. The method of claim 1, wherein the virtual interaction is an email thread, and wherein the virtual interaction data comprises a sequence of emails.

5. The method of claim 1, further comprising:
enabling a client device associated with the virtual interaction to determine a meeting intent by comparing the virtual interaction data to a set of pre-determined keywords; and
verifying the meeting intent based on the virtual interaction data using a natural language processing (NLP) model.

6. The method of claim 1, further comprising:
determining identifications of one or more users mentioned in the virtual interaction.

7. The method of claim 6, further comprising:
determining a social graph based on historical virtual interaction data and profile data associated with the multiple participants and the one or more users mentioned the virtual interaction; and
predicting the multiple attendees based on the social graph.

8. The method of claim 1, further comprising determining the participant receiving the meeting schedule suggestion based on the virtual interaction data in the virtual interaction.

9. The method of claim 1, wherein the meeting schedule suggestion is provided in an interactive graphical user interface (GUI) element presenting the meeting title, the identifications of the multiple attendees, and the one or more meeting times, wherein the interactive GUI element is linked to a meeting application, wherein the meeting application is configured to provide an interactive scheduling window in response to the interactive GUI element being activated.

10. The method of claim 9, wherein the scheduling window is automatically filled with the meeting title, the identifications of the multiple attendees, and a meeting time of the one or more meeting times.

11. The method of claim 9, wherein the interactive scheduling window is configured to receive a user input and update the meeting title, the identifications of the multiple attendees, or the meeting time based on the user input.

12. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access virtual interaction data associated with a virtual interaction;
detect a meeting intent based on the virtual interaction data;
predict multiple meeting attendees based on the virtual interaction data and account information associated with multiple participants in the virtual interaction;
determine one or more meeting times based on the virtual interaction data and online calendar data associated with the multiple meeting attendees;
generate a meeting title based on the virtual interaction data by using a generative artificial intelligence (AI) model; and
provide a meeting schedule suggestion to a participant in the virtual interaction, the meeting schedule suggestion comprising the meeting title, identifications of the multiple attendees, and the one or more meeting times.

13. The system of claim 12, wherein the one or more processors are configured to execute further processor-executable instructions stored in the non-transitory computer-readable medium to:
enable a client device associated with the virtual interaction to determine a meeting intent by comparing the virtual interaction data to a set of pre-determined keywords; and
verify the meeting intent based on the virtual interaction data using a natural language processing (NLP) model.

14. The system of claim 12, wherein the one or more processors are configured to execute further processor-executable instructions stored in the non-transitory computer-readable medium to:
determine identifications of one or more users mentioned in the virtual interaction.

15. The system of claim 12, wherein the one or more processors are configured to execute further processor-executable instructions stored in the non-transitory computer-readable medium to:
determine a social graph based on historical virtual interaction data and profile data associated with the multiple participants and the one or more users mentioned the virtual interaction; and
predict the multiple attendees based on the social graph.

16. The system of claim 12, wherein the one or more processors are configured to execute further processor-executable instructions stored in the non-transitory computer-readable medium to:
determine the participant receiving the meeting schedule suggestion based on the virtual interaction data in the virtual interaction.

17. The system of claim 12, wherein the meeting schedule suggestion is provided in an interactive graphical user interface (GUI) element presenting the meeting title, the identifications of the multiple attendees, and the one or more meeting times, wherein the interactive GUI element is linked to a meeting application, wherein the meeting application is configured to provide an interactive scheduling window in response to the interactive GUI element being activated, wherein the scheduling window is automatically filled with the meeting title, the identifications of the multiple attendees, and a meeting time of the one or more meeting times, and wherein the interactive scheduling window is configured to receive a user input and update the meeting title, the identifications of the multiple attendees, or the meeting time based on the user input.

18. A non-transitory computer-readable medium comprising processor-executable instructions configured to cause one or more processors to:
access virtual interaction data associated with a virtual interaction;
detect a meeting intent based on the virtual interaction data;
predict multiple meeting attendees based on the virtual interaction data and account information associated with multiple participants in the virtual interaction;
determine one or more meeting times based on the virtual interaction data and online calendar data associated with the multiple meeting attendees;
generate a meeting title based on the virtual interaction data by using a generative artificial intelligence (AI) model; and
provide a meeting schedule suggestion to a participant in the virtual interaction, the meeting schedule suggestion comprising the meeting title, identifications of the multiple attendees, and the one or more meeting times.

19. The non-transitory computer-readable medium of claim 18, further comprising processor-executable instructions configured to cause one or more processors to:
determine a meeting intent by comparing the virtual interaction data to a set of pre-determined keywords; and
verify the meeting intent based on the virtual interaction data using a natural language processing (NLP) model.

20. The non-transitory computer-readable medium of claim 18, further comprising processor-executable instructions configured to cause one or more processors to:
determine a social graph based on historical virtual interaction data and profile data associated with the multiple participants in the virtual interaction and one or more users mentioned the virtual interaction; and
predict the multiple attendees based on the social graph.
